(19) United States
(12) Patent Application Publication
(10) Pub. No.: US 2026/0025675 A1
(43) Pub. Date: Jan. 22, 2026

(54) WIRELESS CLIENT EXPERIENCE REPORTING IN WIRELESS NETWORKS

(71) Applicant: Cisco Technology, Inc., San Jose, CA (US)

(72) Inventors: Brian D. Hart, Sunnyvale, CA (US); Arun G. Khanna, Sunnyvale, CA (US); Vishal Satyendra Desai, San Jose, CA (US); Binita Gupta, San Diego, CA (US); Jerome Henry, Pittsboro, NC (US)

(21) Appl. No.: 19/256,560

(22) Filed: Jul. 1, 2025

Related U.S. Application Data
(60) Provisional application No. 63/671,888, filed on Jul. 16, 2024.
(60) Provisional application No. 63/709,811, filed on Oct. 21, 2024.

(51) Int. Cl. H04W 24/02; H04W 84/12

(52) U.S. Cl. CPC H04W 24/02; H04W 84/12

(57) ABSTRACT

A method for managing and controlling a wireless network includes detecting, by a wireless client, at least one operational metric associated with operations of the wireless client in a wireless local area network (WLAN) infrastructure, wherein the at least one operational metric is determined by the wireless client in response to wireless service supplied by the WLAN infrastructure, generating a client experience score based on the at least one operational metric, and transmitting the client experience score to a controller, which is configured to adjust, in response to the client experience score, at least one operational parameter of the WLAN infrastructure to cause a change to the at least one operational metric and to a subsequently generated client experience score.

### CROSS REFERENCE TO RELATED APPLICATIONS

This application claims the benefit of U.S. Provisional Application No. 63/671,888 filed Jul. 16, 2024, and the benefit of U.S. Provisional Application No. 63/709,811 filed Oct. 21, 2024, the subject matter of each of which is incorporated herein by reference in its entirety.

### TECHNICAL FIELD

The present disclosure relates to wireless network management, and more particularly to a system that enables a wireless client to report on its operational experience so that a network infrastructure can respond to the reported operational experience and improve that experience.

### BACKGROUND

In IEEE 802.11 wireless networks, access points (APs) that serve wireless clients have many control “knobs,” i.e., settings, which may be configured at different time scales and that contribute to the wireless client experience. APs, and perhaps a related controller, using measures available to the APs, optimize the settings of those knobs with the intention to elevate or improve the wireless client experience to the extent possible.

However, the measures available to the APs may not capture the full dimension of a wireless client's experience and thus might not lead to an experience that is expected or desirable by the wireless client itself or its user.

### BRIEF DESCRIPTION OF THE DRAWINGS

FIG. 1 illustrates an example of a wireless local area network (WLAN) infrastructure deployment with multiple access points (APs), along with wireless clients, in which the techniques presented herein may be used for each wireless client to report a Client Experience Score using Client Experience Score Generating Logic, according to an example embodiment.

FIG. 2 shows an example of a wireless network deployment in a stadium or arena in which antennas of APs are designed and arranged such that AP-to-AP signal strength measurements are much weaker than AP-to-wireless client signal strength measurements.

FIG. 3 identifies examples of various control “knobs” associated with wireless APs for different time scales that can be used according to the techniques herein to influence the experience of a wireless client device, according to an example embodiment.

FIG. 4 is a diagram illustrating a general operational flow according to techniques presented herein.

FIG. 5 illustrates examples of Client Experience Scores for different categories/topics/aspects associated with experiences of wireless clients in the WLAN infrastructure, according to an example embodiment.

FIG. 6 illustrates techniques for reporting more-granular Client Experience Scores and the components thereof by wireless clients in the WLAN infrastructure, according to an example embodiment.

FIG. 7 illustrates a sequence or protocol diagram depicting operations to request one or more Client Experience Scores from a wireless client, according to an example embodiment.

FIG. 8 is a flowchart depicting a series of operations associated with Client Experience Generating Logic that operates to generate a Client Experience Score, according to an example embodiment.

FIG. 9 is a block diagram of a computing device that may be configured to execute Client Experience Score Generating Logic, according to an example embodiment.

### DETAILED DESCRIPTION

### Overview

A method for managing and controlling a wireless network is provided. The method includes detecting, by a wireless client, at least one operational metric associated with operations of the wireless client in a wireless local area network (WLAN) infrastructure, wherein the at least one operational metric is determined by the wireless client in response to wireless service supplied by the WLAN infrastructure, generating a client experience score based on the at least one operational metric, and transmitting the client experience score to a controller, which is configured to adjust, in response to the client experience score, at least one operational parameter of the WLAN infrastructure to cause a change to the at least one operational metric and to a subsequently generated client experience score.

In another embodiment, a system includes an access point (AP), a wireless network controller, which controls the AP, the AP and the wireless network controller together enabling a wireless local area network (WLAN) infrastructure, and a wireless client, each of the AP, the wireless network controller, and the wireless client including an interface configured to enable network communications, a memory, and one or more processors coupled to the interface and the memory, wherein the wireless client is configured to: detect at least one operational metric associated with operations of the WLAN infrastructure, wherein the at least one operational metric is determined by the wireless client in response to wireless service supplied by the WLAN infrastructure, generate a client experience score based on the at least one operational metric, and transmit the client experience score to at least one of the AP and the wireless network controller, wherein at least one of the AP and the wireless network controller is configured to adjust, in response to the client experience score, at least one operational parameter of the WLAN infrastructure to cause a change to the at least one operational metric and to a subsequently generated client experience score.

### Example Embodiments

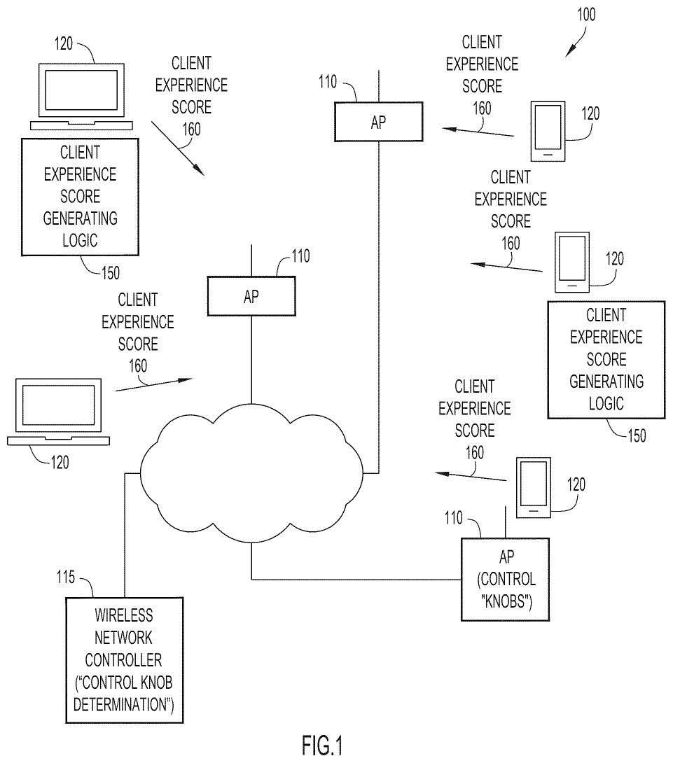

FIG. 1 illustrates an example of a wireless local area network (WLAN) infrastructure deployment with multiple access points (APs) and wireless clients, in which the techniques presented herein may be used for each wireless client to report a Client Experience Score using Client Experience Score Generating Logic 150, according to an example embodiment. More specifically, a WLAN infrastructure 100 includes one or more APs 110 that are in communication with a wireless network controller 115 (which itself could be part of one or more of the APs 110). The APs 110, in concert with the wireless network controller 115, enable wireless service for wireless clients 120 such as mobile telephones, desktop computers, laptop computers, tablets, Internet of Things (IoT) devices, etc. Operations of WLAN infrastructure 100 may be in accordance with IEEE 802.11 standard and amendments thereof. As will be explained in more detail below, each wireless client 120 hosts Client Experience Score Generating Logic 150 that is configured to generate a Client Experience Score 160. The Client Experience Score 160 is a value (or multiple values) that represents an operational satisfaction measure that is determined natively by the wireless client 120 and which is sensitive to service delivered or supported by the WLAN infrastructure 100. In an embodiment, the Client Experience Score 160 is sent from the wireless client 120 to an AP 110 and, perhaps, then to wireless network controller 115 so that the AP 110 and/or wireless network controller 115 can respond to a given Client Experience Score 160 by modifying or adjusting at least one operational parameter of the WLAN infrastructure 100 to cause a later-generated or subsequently-generated Client Experience Score 160 of the wireless client 120 to improve in response to the wireless client 120 sensing an improved wireless experience or environment.

Those skilled in the art will appreciate that there may be hundreds or even thousands of wireless clients 120 being served by WLAN infrastructure 100, and typically, a single poor Client Experience Score 160 from a given wireless client 120 might not cause an adjustment of any WLAN infrastructure 100 operational parameter. On the other hand, as an increasing number of wireless clients 120 send “poor” Client Experience Scores 160, then WLAN infrastructure 100 may elect to make such adjustment(s). Whether to make an adjustment may be based on an overall average, a predetermined threshold number of “poor” scores, or some other metric.

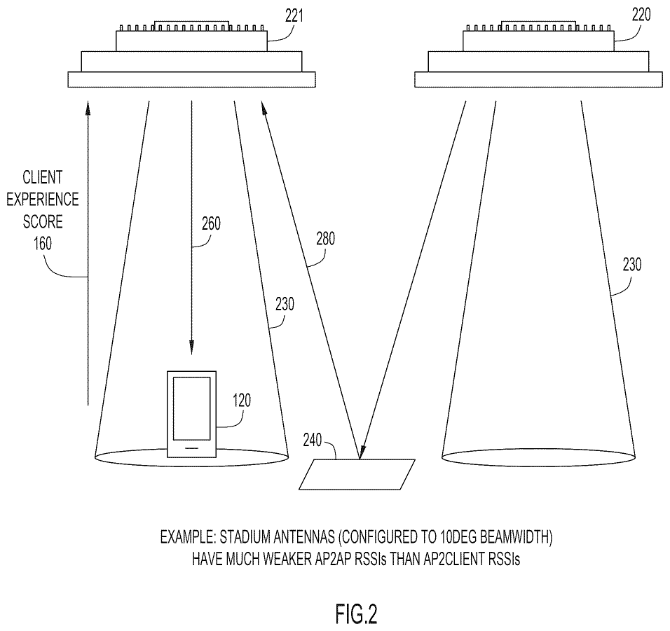

FIG. 2 shows an example of a wireless network deployment in a stadium or arena in which highly-directional antennas of a first AP 220 and a second AP 221 are arranged such that AP-to-AP signal strength measurements are much weaker than AP-to-wireless client signal strength measurements. That is, assume the RF transmit power of the first AP 220 and the second AP 221 are the same and each transmits in a relatively narrow (e.g., 10 degree) beamwidth 230. Some of the RF power from first AP 220 is reflected from one or more surfaces 240 and is received by second AP 221. The reflected power 280 may be represented by an AP-to-AP signal strength in the form of a first Received Signal Strength Indicator (RSSI) value. Meanwhile, wireless client 120 may be receiving RF transmissions 260 from second AP 221. The second AP 221 may wish to know the interference level (RSSI) of the first AP 220 at the wireless client 120, and uses as a proxy the RSSI of the first AP 220 at the second AP 221. However, a second RSSI value corresponding to the first-AP-to-wireless client RSSI will likely be higher than the first RSSI value. Thus, this is an example of the WLAN infrastructure 100, e.g., the wireless network controller 115, not being aware of the actual interference level (RSSI) being experienced by the wireless client 120. The only RSSI value readily known to second AP 221 is the first RSSI value, the AP-to-AP signal strength, not the second RSSI value, the first-AP-to-wireless client 120 signal strength. To address this “missing” information, and in accordance with an embodiment, wireless client 120 may send a Client Experience Score 160 to second AP 221 to notify the wireless infrastructure that the interference received signal strength of the wireless client 120 is acceptably low (or not), even if wireless network controller 115 might determine that, given the lower first interference RSSI value (AP-to-AP signal strength) measured by the second AP 221, lowered power sent by the second AP 221 might be tolerable.

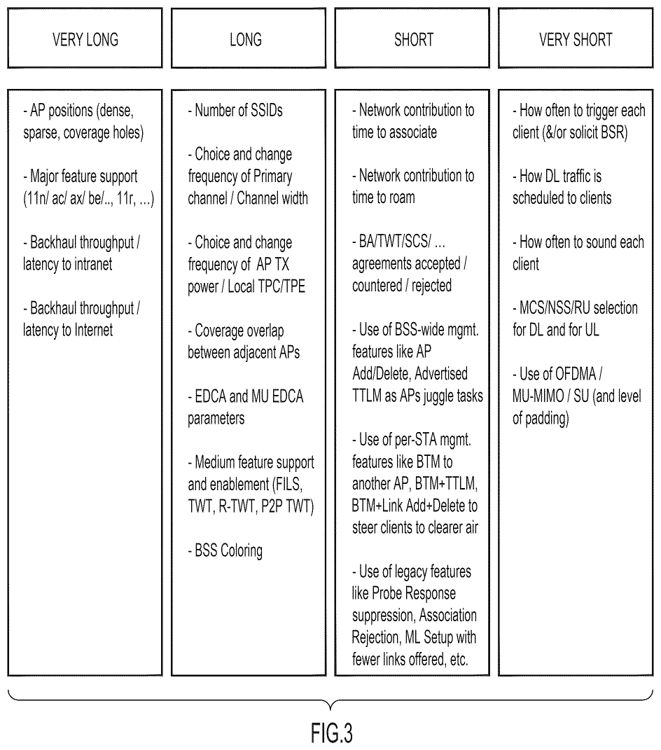

It is noted that transmit power is merely one among many possible “knobs” that the wireless network controller 115 or APs 110 can control to achieve an expected level of wireless service in WLAN infrastructure 100. In this regard, FIG. 3 identifies examples of various control “knobs” associated with APs 110 for different time scales that can be used according to the techniques herein to elevate or improve the experience of a wireless client 120, according to an example embodiment. That is, once a given Client Experience Score 160 is received, via an AP 110, and possibly further at wireless network controller 115, AP 110 and/or wireless network controller 115 may be configured to modify or adjust at least one operational parameter, or “knob,” of the WLAN infrastructure 100 in response to the Client Experience Score 160. Referring again to FIG. 1, wireless network controller 115 may be configured to determine settings for various control knobs (“control know determination”), while AP 110 may be configured implement the indicated setting, with the control “knobs.” Examples of such parameters or “knobs” are presented in FIG. 3 under the time scale categories of “very long,” “long,” “short,” and “very short.”

The “very long” category may include AP positions, including whether the APs 110 make up a dense or sparse topology, and whether there are coverage holes, whether the APs 110 support major features such as IEEE 802.11n/ac/ax/be/ . . . , 11r, etc., backhaul throughput/latency to intranet, and backhaul throughput/latency to Internet.

The “long” category may include number of Service Set IDs (SSIDs), choice and change frequency of Primary channel/Channel width, choice and change frequency of AP TX power/Local Transmit Power Control (TPC)/Transmit Power Envelop (TPE), coverage overlap between adjacent APs, Enhanced Distributed Channel Access (EDCA) and Multi User (MU) EDCA parameters, medium-importance feature support and enablement (such as Fast Initial Link Setup (FILS), Target Wake Time (TWT), Restricted TWT (R-TWT), Peer-to-Peer TWT (P2P TWT), and Basic Service Set BSS) coloring).

The “short” category may include network contribution to time to associate, network contribution to time to roam, which Block Acknowledgement (BA)/TWT/Stream Classification Service (SCS), etc. agreements are accepted or not, use of proactive BSS-wide management features such as AP Add/Delete, Advertised Traffic Identifier (TID) to Link Mapping (TTLM), Quiet element, use of proactive per-STA management features such as BSS (Basic Service Set) Transition Management (BTM) to another AP, BTM+TTLM, use of reactive features such as Probe Response suppression, Association Rejection, and Multi-Link (ML) Setup with fewer links offered, etc.

The “very short” category may include how often to trigger each wireless client 120 (and/or solicit a Buffer Status Report (BSR)), how often to sound each wireless client 120, how downlink (DL) traffic is scheduled to wireless clients 120, Modulation Coding Scheme (MCS)/Number of Spatial Streams (NSS) selection for DL and for uplink (UL), use of Orthogonal Frequency Division Multiple Access (OFDMA)/Multi-User Multiple-Input and Multiple-Output (MU-MIMO)/Single User (SU) (and level of padding).

With the foregoing in mind, a given AP 110 has many “knobs,” measures, or measurements that help to deliver a desired or intended experience for wireless client 120. These include:
Brief onboarding time
Reliable Dynamic Host Configuration Protocol (DHCP), Domain name Service (DNS), walled garden, application performance
   Ongoing assurance testing via wireless network controller or other system network performance measurements
Comprehensive wireless coverage throughout the deployment
Channel utilization not too high
   Few co-channel APs, high throughput for offered load
Low proportion of retries with respect to tries
   Low latency, high power efficiency
Especially for QoS TIDs, transmit buffers are shallow almost always
   Low latency
High MCSs/NSSs/data rate with individual clients
High system throughput/efficiency
   High degree of spatial reuse via AP 110/wireless client 120 power control
Service Level Agreements (SLAs) expressed by SCS (QC) met (with margin)·
Brief outages during roaming
   Solid coverage overlap between adjacent APs 110

The challenge is that the foregoing list of measures and measurements is incomplete. It does not include the perspective of the experience of the wireless client 120. For example, what matters to a wireless client 120 may be:
Connectivity (to intranet, Internet)
Coverage, Throughput, Latency & Jitter
   Determined in turn by RSSI, interference level, contending Wi-Fi devices, deferring due to non-Wi-Fi emissions, etc.
Power efficiency
Roaming experience
In-device coexistence mitigation
Privacy
Or still other considerations

Notably, AP 110 is not directly aware of many of these parameters. For example, each AP 110 may aim for a minimum downlink (DL) RSSI and uplink (UL) RSSI everywhere, but only has intermittent access to DL RSSI measurements via IEEE 802.11k Beacon Reports. Moreover, AP-to-AP RSSI measurements are an inferior substitute for DL and UL RSSI measurements, as explained in connection with FIG. 2. Some other non-limiting specific examples of desired wireless experience for wireless client 120 are:
Wireless client 120 might prefer a brief onboarding time, but AP 110 might not know when the onboarding effort of the wireless client 120 first started.
Wireless client 120 might desire comprehensive wireless coverage throughout the deployment, but wireless client 120 may experience a coverage hole between two APs 110, yet this does not register (the network might just assume that wireless client 120 is in a deep sleep).
Since interference at wireless client 120 is not the same as interference at AP 110 in general (consider discussion regarding FIG. 2), AP 110 might be unaware of strong local interference at wireless client 120.
Since collided or otherwise unreceivable wireless client 120 transmissions at AP 110 are not visible to AP 110, AP 110 cannot determine when they were sent (i.e., a wireless client 120 could send statistics on this such as the number of MPDU transmissions with acknowledgement requested plus the number of MPDU failures, and also the number of MPDU transmissions where acknowledgement is not requested).
AP 110 does not know when wireless client 120 has a MAC Service Data Unit (MSDU) ready for transmission, so it does not know the total wireless latency.
For Stream Classification Service (SCS) frames with a QoS Characteristics element, wireless client 120 sets a Service Level Agreement (SLA), but AP 110 does not always know if this is being met, especially if no Service Start Time is provided. Specifically, AP 110 might not see expired traffic and may not know the buffered time of traffic at wireless client 120. This applies similarly for Restricted Target Wake Time (R-TWT); what level of performance does the client perceive versus the SLA.
During wireless client 120 roaming, AP 110 does not know how long the “data pause” at the wireless client 120 lasts and the longest that (QoS) traffic was delayed.

Embodiments described herein are configured to signal these “operational metrics” and other issues to the network infrastructure either explicitly or via some aggregated or cumulative indication.

In this regard, techniques are presented herein to enable wireless clients 120 to report their recent client experience, in the form of a Client Experience Score 160, to the WLAN infrastructure 100 (e.g., wireless network controller 115, APs 110, etc.), and thereby provide the system with information to improve the collective wireless client 120 experience. These techniques may involve ongoing trialing of alternatives to discover how to maximize the client experience. The trialing can be manual or automatic via a closed loop optimization, possibly using artificial intelligence/machine learning (AI/ML) algorithms, with guard rails.

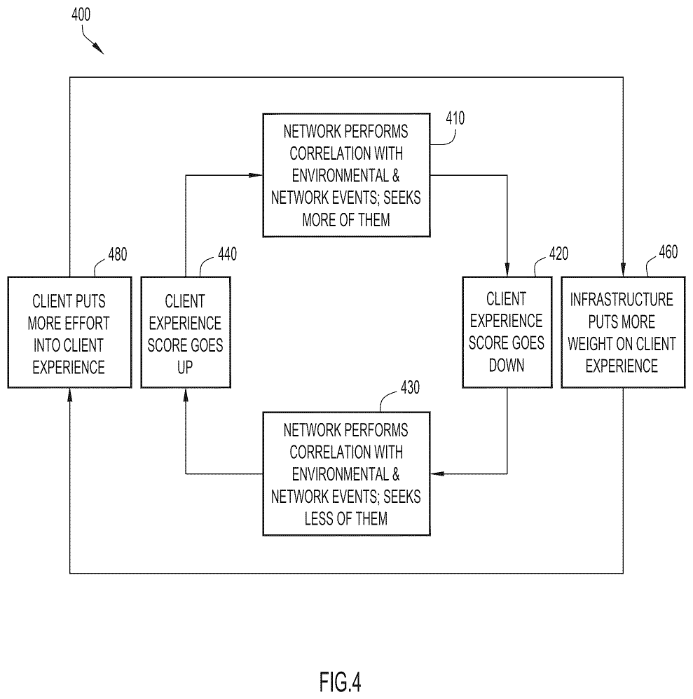

FIG. 4 is a diagram illustrating a general operational flow 400 according to techniques presented herein. Those skilled in the art will appreciate that general operational flow 400 is an iterative process that may continually operate based on the state of the network at any given time. Due to client behavior/requirements, network behavior or environmental events, at 420, the Client Experience Score 160 may go down. In response, at 430, the network performs correlation with environmental and network events, and may seek less of the “unwelcome” network behavior or environmental events. If the network modifies its behavior so as to foster a more conducive client experience, at 440, the Client Experience Score 160 may go up. At 410, the network performs correlation with environmental and network events, and may seek still more of the same, which returns the general operational flow 400 to 420. In the meantime, as an outer loop operating at much slower pace (e.g., “hundreds” or “millions” of iterations of the inner loop for every one iteration of the outer loop) at 460, during a period when the Client Experience Score 160 is down, the infrastructure may put more weight on improving the client experience. Likewise, at a time when the Client Experience Score 160 goes up, at 480, the wireless client 120 may put more effort into generating the Client Experience Score 160 (e.g., the wireless client is updated to use more data, or more parameters).

In a manual mode and for example, if the Client Experience Score 160 drops broadly after roll-out of a new infrastructure software release, then an administrator may pull the release and investigate the root cause of the problem. Rollback could also be executed automatically.

If the Client Experience Score 160 is low (or drops) for a few client devices from one vendor, then an administrator may contact the vendor and clarify their concern.

If Client Experience Score 160 is low (or drops), an administrator or provider may add more APs/move APs/upgrade APs/implement feature X/enable feature Y.

In accordance with an embodiment, the Client Experience Score 160 can be consumed by the AP 110 and/or network automatically. For example, Artificial Intelligence/Machine Learning (AI/ML) may be leveraged to control Radio Resource Management (RRM) to improve the experience of a wireless client 120. In another example, the network may correlate scores against events, as shown in FIG. 4, and may perform ongoing trialing of alternatives (using its control knobs) to discover how to maximize the Client Experience Score 160 (e.g., by tweaking RRM behavior/tweaking scheduler behavior). In the automated, and particularly AI/ML response realm, embodiments contemplate using the Client Experience Score 160 for a “reality-check” in connection with training, validation, and test data sets.

In an embodiment, the wireless client 120, using Client Experience Score Generating Logic 150, is configured to calculate a Client Experience Score 160 such that the wireless client 120 would be “happier” with a network that it describes by a higher score than by a lower score. The WLAN infrastructure 100 incorporates this feedback and makes increased wireless client 120 satisfaction an explicit component of its overall goal. The effort that the wireless client 120 puts into the score that the wireless client 120 reports may impact how much consideration the infrastructure gives it, and thus what the wireless client 120 gets out of the network (i.e., virtuous circle to spur more effort), as shown in the outer loop of FIG. 4.

Several approaches for generating Client Experience Score 160 are possible according to the embodiments described herein.

Approach A—One Client Experience Score (with Enhancements)

Wireless client 120 (executing Client Experience Score Generating Logic 150) may be configured to generate and report a Client Experience Score 160 (“Health Score”) as a numerical value such as e.g., 1 (all but unusable) to 255 (faultless). To accommodate the range of wireless clients 120 (e.g., IoT devices, smart phones, laptops computers, etc.) and how much “effort” they can allocate to determining a Client Experience Score 160, exactly how a wireless client 120 generates the value may be implementation dependent. In an embodiment, a numerical indicator of that “effort” may also be supplied along with the Client Experience Score 160, perhaps reserving two out of eight bits for an “effort” value. The “effort” value may be based on a number of parameters used, the frequency with which those parameters were monitored, and/or a difficulty with which it is to detect the parameters, among other possible considerations, to generate the Client Experience Score 160. The overarching process is that the wireless client 120 picks/selects a way to calculate its Client Experience Score 160 such that the wireless client 120 would be “happier” with a network that it describes by a higher score than by a lower score. Although signaling might support N bits (e.g., N=8, to allow for sending a Client Experience Score 160 of 1 to 255), a client implementation might only use a subset of these values (e.g., 1, 128 or 255 to indicate a poor, neutral or positive client experience respectively). A simple 5-point scale might be used instead. The WLAN infrastructure 100 might reserve one value (e.g., 0) for wireless clients 120 whose experience is so bad that they cannot even communicate a Client Experience Score 160 with the network. In another embodiment, instead of a higher score indicating a better experience, a lower score might indicate a better experience.

The wireless client 120 can also report area(s)/topics/features/parameters for improvement by the network. This enhanced information may be provided in a custom Information Element (IE) reserved for such notification. The union of defined areas/parameters may provide complete coverage of the network characteristics. Each area may be specific enough that the network can reasonably identify what kind of actions would mitigate the concern. For example, the wireless clients 120 can report on parameters for improvement in 802.11 coverage/throughput, 802.11 latency/jitter, scanning and roaming, reliability, power efficiency, in-device coexistence, security/upper layers, backhaul, etc.

Wireless client 120 may send the Client Experience Score 160 to the AP 110 that the wireless client 120 is associated to, and the Client Experience Score 160 may be processed locally by the AP 110, and/or the Client Experience Score 160 may be processed by the wireless network controller 115.

### Approach B—Multiple Client Experience Scores, One per Topic (+Effort)

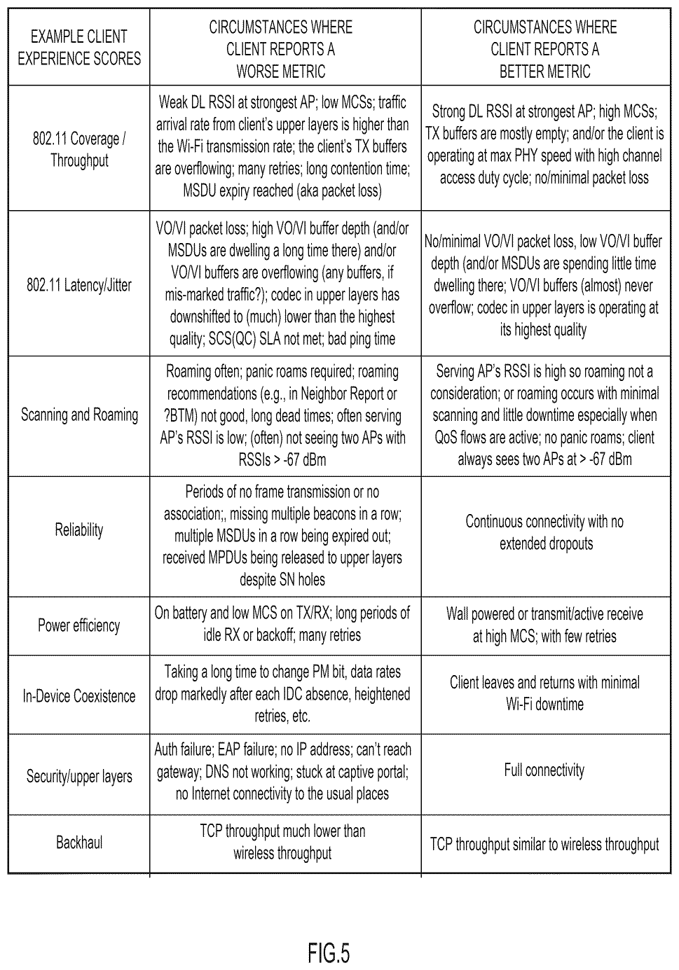

For Approach B, FIG. 5 illustrates examples of categories for Client Experience Scores 160 for wireless clients 120 served by WLAN infrastructure 100, according to an example embodiment. The following categories can be represented by their own respective Client Experience Score 160 and delivered to AP 110 as a collection or aggregation of scores. A custom Information Element may be provided to deliver the individual Client Experience Scores 160 and/or an aggregated Client Experience Score 160.

### 802.11 Coverage/Throughput:

Circumstances where wireless client 120 reports a worse metric
   Weak DL RSSI at strongest AP 110; low MCSs; traffic arrival rate from wireless client's 120 upper layers is higher than the Wi-Fi transmission rate; the transmit (TX) buffers of the wireless client 120 are overflowing; many retries; long contention time; MSDU expiry reached (aka packet loss).
Circumstances where wireless client 120 reports a better metric
   Strong DL RSSI at strongest AP 110; high MCSs; TX buffers are mostly empty; and/or the wireless client 120 is operating at max PHY speed with high channel access duty cycle; no/minimal packet loss.

### 802.11 Latency/Jitter:

Circumstances where wireless client 120 reports a worse metric
   Voice or video (VO/VI, respectively) packet loss; high VO/VI buffer depth (and/or MSDUs are dwelling a long time there) and/or VO/VI buffers are overflowing (any buffers, if mis-marked traffic?); codec in upper layers has downshifted to (much) lower than the highest quality; Stream Classification Service (SCS (QC)) SLA not met; bad ping time.
Circumstances where wireless client 120 reports a better metric
   No/minimal VO/VI packet loss, low VO/VI buffer depth (and/or MSDUs are spending little time dwelling there; VO/VI buffers (almost) never overflow; codec in upper layers is operating at its highest quality.

### Scanning and Roaming:

Circumstances where wireless client 120 reports a worse metric
   Last-second panic roams required; roaming recommendations (e.g., in Neighbor Report or BTM) not good, long dead times; often serving AP's 110 RSSI is low; (often) not seeing two APs 110 with RSSIs >−67 dBm.
Circumstances where wireless client 120 reports a better metric
   Serving AP's 110 RSSI is high so roaming not a consideration; or roaming occurs with minimal scanning and little downtime especially when QoS flows are active; no panic roams; client always sees two APs at >−67 dBm.

### Reliability:

Circumstances where wireless client 120 reports a worse metric
   Periods of no frame transmission or no association, missing multiple beacons in a row, multiple MSDUs in a row being expired out; received MPDUs being released to upper layers despite sequence number (SN) holes (i.e., missing MPDUs in the same TID).
Circumstances where wireless client 120 reports a better metric
   Continuous connectivity with no extended dropouts.
      Power efficiency:
Circumstances where wireless client 120 reports a worse metric
   On battery (or general battery usage) and low MCS on TX/RX; long periods of idle RX or backoff; many retries.
Circumstances where wireless client 120 reports a better metric
   Wall powered or transmit/active receive at high MCS; with few retries and less time spent performing idle receive (i.e., waiting to receive a PHY Protocol Data Unit (PPDU)).

### In-Device Coexistence (IDC) (e.g., LTE/5G, Wi-Fi, Bluetooth, and GNSS):

Circumstances where wireless client 120 reports a worse metric
   Taking a long time to change power management (PM) bit, data rates drop markedly after each IDC unavailability, heightened retries, etc.
Circumstances where wireless client 120 reports a better metric
   Wireless client 120 becomes unavailable then later becomes unavailable again with minimal Wi-Fi downtime.
      Security/upper layers:
Circumstances where wireless client 120 reports a worse metric
   Authorization failure; Extensible Authentication Protocol (EAP) failure; no IP address; cannot reach gateway; DNS not working; stuck at captive portal; no Internet connectivity to the usual places.
Circumstances where wireless client 120 reports a better metric
   Full connectivity.

### Backhaul:

Circumstances where wireless client 120 reports a worse metric
   TCP throughput much lower than wireless throughput.
Circumstances where wireless client 120 reports a better metric
   TCP throughput similar to wireless throughput.

### Approach C—Extensible Issue Reporting

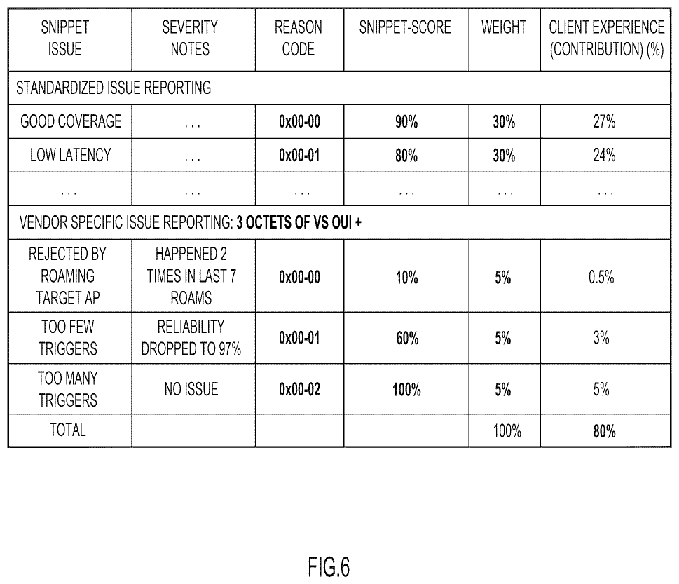

FIG. 6 illustrates Approach C, which depicts techniques for reporting a more-granular Client Experience Score 160 by wireless clients 120 in WLAN infrastructure 100, according to an example embodiment. The table of FIG. 6 shows an extensible table that can be completed or populated with parameters (each identified by a reason code), scores, and/or weights, and an overall Client Experience Score 160 where the parameters are representative of/help characterize the wireless experience for a wireless client 120. The table of FIG. 6 may be stored on wireless client 120, and then Client Experience Score Generating Logic 150 may use the stored data to generate an aggregated overall Client Experience Score 160, or the highlighted portions of the table itself (or some subset of the highlighted portions) may be delivered to AP 110 such as optionally inside an information element, but either way are carried inside a management frame.

In an example operation, wireless client 120 populates the Client Experience Scores 160 via multiple snippets of extra code that each identifies a good/bad experience. The wireless client 120 might assign each (snippet) issue a snippet-score and weight. A (snippet) issue might also depend on state, such as the number of times an event occurred, and how many of those events were associated with a bad outcome. For communication purposes, a (snippet) issue might also be assigned a reason code. Then the wireless client 120 (i.e., Client Experience Score Generating Logic 150) aggregates the weighted snippet-scores to form the overall Client Experience Score 160. In the example of FIG. 6, the overall Client Experience Score 160 (80%) is listed in the bottom right corner of the table as the sum of the weighted snippet-scores. Other mathematical means of summarizing the snippet-scores are allowed as well, such as reporting the worst-case snippet score, or some other nonlinear function such as to emphasize a particularly poor score for a particularly important aspect of the client experience. Some embodiments of the summarization function show an improvement in the score if secondary characteristics improve even if the primary characteristic is unchanged (i.e., reporting the worst-case snippet-score, aka using the min(.) operator to determine the overall Client Experience Score 160, may not be a desirable implementation).

As shown in FIG. 6, the wireless client 120 can express its (dis) satisfaction more clearly and the network can learn and converge faster if the wireless client 120 reports are at the snippet-issue level—i.e., before aggregation. Thus, as mentioned, a pre-aggregated Client Experience Score 160 can also be sent to an AP 110.

In an embodiment, and as noted, a code snippet may be identified by a Reason Code, and with a corresponding snippet-score and (optionally) weight. Then the wireless client 120 can send (all or, e.g., the highlighted elements in the table of FIG. 6):
Approach A content (overall Client Experience Score, etc.)
Multiple (Reason Codes, Snippet-Scores, Weights) tuples; e.g., all or just the highlights:
   Best or improving//i.e., “keep it up”
   Worst or worsening//i.e., “less of this please”
   Most long-lived albeit minor snippet-issues

It is noted that it may be difficult to standardize a Reason Code for each code snippet. As a result, an array of extensible Vendor Specific (VS) Reason Codes, possibly associated with Organizationally Unique Identifier (OUI) may also be sent as part of the Client Experience Score 160. Vendors can publish/communicate their reason codes with peers and/or add a Topic to each tuple for greater clarity and/or recipients can use artificial intelligence/machine learning (AI/ML) in the cloud to correlate reason codes with local events. In another embodiment, the approach of sending granular extensible reason codes may be used with Approach B content (i.e., one Client Experience Score 160 per Topic).

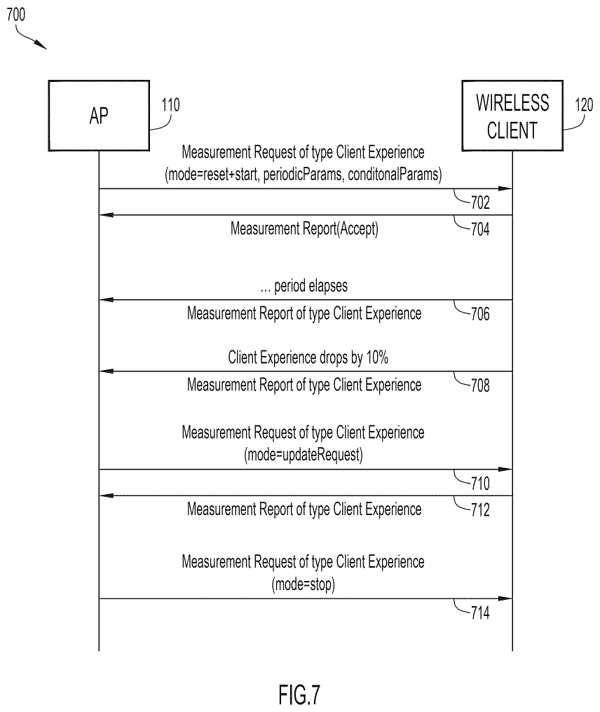

FIG. 7 illustrates a sequence or protocol diagram depicting operations to request one or more Client Experience Scores 160 from a wireless client 120, according to an example embodiment. To calibrate/compare the experience score information over time as the client mix evolves, the following may be performed: the Client Experience Score(s) 160 may be subject to quantitative guidelines, and/or the sender identifies itself via one or more of: device type/make/model/SW versions/chipset identifier via IEEE 802.11v.

To obtain a Client Experience Score 160 from a given wireless client 120, the protocol/process flow 700 shown in FIG. 7 may be executed and may involve the following operations.

At 702, AP 110 may send a Measurement Request indicating that the wireless client 120 should reset any pre-existing score-related state and begin generating a new Client Experience Score(s) 160, to be reported at a defined single-shot or periodic schedule (e.g., once per xx minutes, in accordance with the delivered periodic parameters) and/or in response to a defined trigger condition (i.e., in accordance with conditional parameters, e.g., experience scores have markedly increased or decreased, e.g., +/−20%). It is noted that resetting experience score related data at the same time as the network makes a change allows the AP 110 or wireless network controller 115 to compare a newly-received Client Experience Score 160 (that purely reflects the client's experience after the change) with one or more prior scores (that purely reflect the client's experience before the change), and thus learn the positive or negative or neutral effects of the change on the client experience of the wireless client 120.

At 704, wireless client 120 accepts the request. If the request is scheduled, after each predetermined period of time, at 706, wireless client 120 sends a Client Experience Score 160.

At 708, if the initial request had been a conditional request, and the score has dropped by, for example, 20%, then wireless client 120 might send a new Client Experience Score 160.

At 710, AP 110 (or wireless network controller 115) might want an instantaneous or latest Client Experience Score 160 and thus makes a request accordingly. In response, at 712, wireless client 120 sends a Client Experience Score 160.

At 714, AP 110 may send a request to stop sending Client Experience Scores 160.

In an embodiment, a Client Experience Score 160 may be generated and sent in connection with wireless client 120 performing a re-association procedure with AP 110, or after roaming to a new AP 110.

In summary, techniques are provided to enable wireless clients 120 to report their recent client experience (“health”) to the network. This allows the system of APs 110 (and compute/control entities such as wireless network controller 115) and wireless clients to have information to improve the collective wireless client 120 experience in the system. These techniques may involve ongoing trialing of alternatives to discover how to maximize the client experience.

In so doing, these techniques provide clients with a “seat at the table” when decisions are being made on the wireless clients' 120 behalf. The goal of this process is for wireless clients 120 to collectively see a higher Client Experience Score 160 corresponding to improved wireless service.

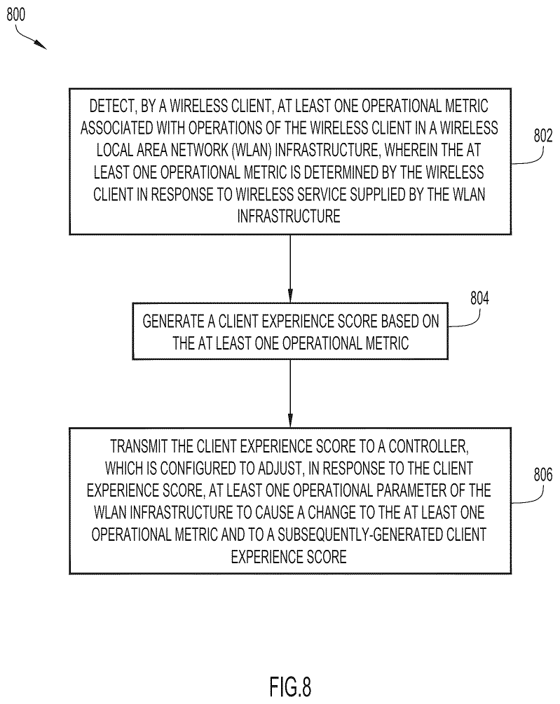

FIG. 8 is a flowchart depicting a series of operations 800 associated with Client Experience Score Generating Logic 150, according to an example embodiment. At 802, an operation including detecting, by a wireless client, at least one operational metric associated with operations of the wireless client in a wireless local area network (WLAN) infrastructure, wherein the at least one operational metric is determined by the wireless client in response to wireless service supplied by the WLAN infrastructure. At 804, an operation includes generating a client experience score based on the at least one operational metric. And, at 806, an operation includes transmitting the client experience score to a controller, which is configured to adjust, in response to the client experience score, at least one operational parameter of the WLAN infrastructure to cause a change to the at least one operational metric and to a subsequently generated client experience score.

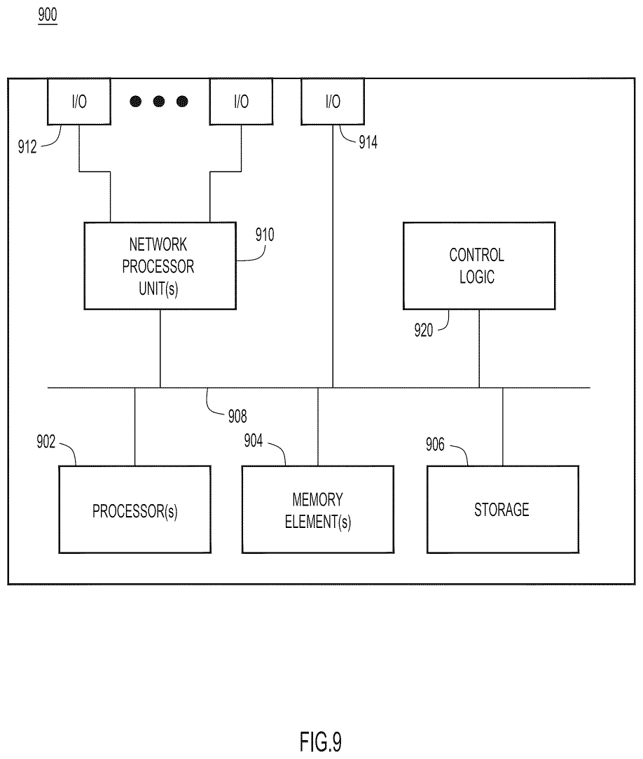

FIG. 9 is a block diagram of a computing device that may be configured to execute Client Experience Score Generating Logic, according to an example embodiment. In various embodiments, a computing device, such as computing device 900 or any combination of computing devices 900, may be configured as any entity/entities as discussed for the techniques depicted in connection with FIGS. 1-8 in order to perform operations of the various techniques discussed herein.

In at least one embodiment, the computing device 900 may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920 (which could be Client Experience Score Generating Logic 150 or the described control “knobs”). In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa) or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., Tl lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

In sum, a method may include detecting, by a wireless client, at least one operational metric associated with operations of the wireless client in a wireless local area network (WLAN) infrastructure, wherein the at least one operational metric is determined by the wireless client in response to wireless service supplied by the WLAN infrastructure, generating a client experience score based on the at least one operational metric, and transmitting the client experience score to a controller, which is configured to adjust, in response to the client experience score, at least one operational parameter of the WLAN infrastructure to cause a change to the at least one operational metric and to a subsequently generated client experience score.

The method may further include transmitting the subsequently generated client experience score to the controller.

In the method, the at least one operational metric associated with operations of the wireless client in the WLAN infrastructure may include at least one of a Received Signal Strength Indicator (RSSI), Modulation Coding Scheme (MCS), state of TX buffer of the wireless client, number of connection retries, contention time, and Media Access Control (MAC) service data unit (MSDU) aggregation.

In the method, the at least one operational metric associated with operations of the wireless client in the WLAN infrastructure may include at least one of voice or video packet loss, voice or video buffer depth, change to codec quality, roaming tendency, periods of no frame transmission or no association, missing beacon, and battery usage.

In the method, the at least one operational metric associated with operations of the wireless client in the WLAN infrastructure may include time to change a power management (PM) bit, authorization failure, Extensible Authentication Protocol (EAP) failure, absence of Internet Protocol (IP) address, failure to reach a gateway, Domain Name Service (DNS) not working, no Internet connectivity, IP, Transmission Control Protocol (TCP), or peer throughput.

In the method, the client experience score may be based on a measure of in-device coexistence.

In the method, the client experience score may include an indication of a level of effort used to generate the client experience score.

In the method, the indication of a level of effort used to generate the client experience score indicates how many parameters were used to calculate the client experience score.

In the method, generating the client experience score may be performed periodically, or upon request by the controller.

In the method, generating the client experience score may be performed as part of a re-association procedure, or after roaming to an access point.

In the method, the client experience score may further include an indication for a request for improvement in a given category of operational metrics, wherein the given category of operational metrics is selected from a plurality of predetermined categories of operational metrics.

In the method, the client experience score may include at least one reason code and an individual score respectively associated with a given operational metric.

In an embodiment, a system may include an access point (AP), a wireless network controller, which controls the AP, the AP and the wireless network controller together enabling a wireless local area network (WLAN) infrastructure, and a wireless client, wherein each of the AP, the wireless network controller, and the wireless client includes an interface configured to enable network communications, a memory, and one or more processors coupled to the interface and the memory, wherein the wireless client is configured to: detect at least one operational metric associated with operations of the WLAN infrastructure, wherein the at least one operational metric is determined by the wireless client in response to wireless service supplied by the WLAN infrastructure, generate a client experience score based on the at least one operational metric, and transmit the client experience score to at least one of the AP and the wireless network controller, and wherein at least one of the AP and the wireless network controller is configured to adjust, in response to the client experience score, at least one operational parameter of the WLAN infrastructure to cause a change to the at least one operational metric and to a subsequently generated client experience score.

In the system, the one or more processors may be configured to transmit the subsequently generated client experience score to the AP.

In the system, the at least one operational metric associated with operations of the wireless client in the WLAN may include at least one of a Received Signal Strength Indicator (RSSI), Modulation Coding Scheme (MCS), state of TX buffer of the wireless client, number of connection retries, contention time, and Media Access Control (MAC) service data unit (MSDU) aggregation.

In the system, the at least one operational metric associated with operations of the wireless client in the WLAN may include at least one of voice or video packet loss, voice or video buffer depth, change to codec quality, roaming tendency, periods of no frame transmission or no association, missing beacon, and battery usage.

In the system, the client experience score may include an indication of a level of effort used to generate the client experience score.

In still another embodiment, one or more non-transitory computer readable storage media encoded with instructions that, when executed by a processor, cause the processor to: detect, by a wireless client, at least one operational metric associated with operations of a wireless local area network (WLAN) infrastructure, wherein the at least one operational metric is determined by the wireless client in response to wireless service supplied by the WLAN infrastructure, generate a client experience score based on the at least one operational metric, and transmit the client experience score to at least one of an access point (AP) and a wireless network controller, which are configured to adjust, in response to the client experience score, at least one operational parameter of the WLAN infrastructure to cause a change to the at least one operational metric and to a subsequently generated client experience score.

The one or more non-transitory computer readable storage media may include instructions that are configured to transmit the subsequently generated client experience score to the AP.

The one or more non-transitory computer readable storage media may include instructions that are configured to include with the client experience score an indication of a level of effort used to generate the client experience score.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
detecting, by a wireless client, at least one operational metric associated with operations of the wireless client in a wireless local area network (WLAN) infrastructure, wherein the at least one operational metric is determined by the wireless client in response to wireless service supplied by the WLAN infrastructure;
generating a client experience score based on the at least one operational metric; and
transmitting the client experience score to a controller, which is configured to adjust, in response to the client experience score, at least one operational parameter of the WLAN infrastructure to cause a change to the at least one operational metric and to a subsequently generated client experience score.

2. The method of claim 1, further comprising:
transmitting the subsequently generated client experience score to the controller.

3. The method of claim 1, wherein the at least one operational metric associated with operations of the wireless client in the WLAN infrastructure comprises at least one of a Received Signal Strength Indicator (RSSI), Modulation Coding Scheme (MCS), state of TX buffer of the wireless client, number of connection retries, contention time, and Media Access Control (MAC) service data unit (MSDU) aggregation.

4. The method of claim 1, wherein the at least one operational metric associated with operations of the wireless client in the WLAN infrastructure comprises at least one of voice or video packet loss, voice or video buffer depth, change to codec quality, roaming tendency, periods of no frame transmission or no association, missing beacon, and battery usage.

5. The method of claim 1, wherein the at least one operational metric associated with operations of the wireless client in the WLAN infrastructure comprises time to change a power management (PM) bit, authorization failure, Extensible Authentication Protocol (EAP) failure, absence of Internet Protocol (IP) address, failure to reach a gateway, Domain Name Service (DNS) not working, no Internet connectivity, IP, Transmission Control Protocol (TCP), or peer throughput.

6. The method of claim 1, wherein the client experience score is based on a measure of in-device coexistence.

7. The method of claim 1, wherein the client experience score includes an indication of a level of effort used to generate the client experience score.

8. The method of claim 7, wherein the indication of a level of effort used to generate the client experience score indicates how many parameters were used to calculate the client experience score.

9. The method of claim 1, wherein generating the client experience score is performed periodically, or upon request by the controller.

10. The method of claim 1, wherein generating the client experience score is performed as part of a re-association procedure, or after roaming to an access point.

11. The method of claim 1, wherein the client experience score further includes an indication for a request for improvement in a given category of operational metrics, wherein the given category of operational metrics is selected from a plurality of predetermined categories of operational metrics.

12. The method of claim 1, wherein the client experience score comprises at least one reason code and an individual score respectively associated with a given operational metric.

13. A system comprising:
an access point (AP);
a wireless network controller, which controls the AP, the AP and the wireless network controller together enabling a wireless local area network (WLAN) infrastructure; and
a wireless client;
wherein each of the AP, the wireless network controller, and the wireless client includes an interface configured to enable network communications, a memory, and one or more processors coupled to the interface and the memory,
wherein the wireless client is configured to:
detect at least one operational metric associated with operations of the WLAN infrastructure, wherein the at least one operational metric is determined by the wireless client in response to wireless service supplied by the WLAN infrastructure;
generate a client experience score based on the at least one operational metric; and
transmit the client experience score to at least one of the AP and the wireless network controller, and
wherein at least one of the AP and the wireless network controller is configured to adjust, in response to the client experience score, at least one operational parameter of the WLAN infrastructure to cause a change to the at least one operational metric and to a subsequently generated client experience score.

14. The system of claim 13, wherein the one or more processors are configured to transmit the subsequently generated client experience score to the AP.

15. The system of claim 13, wherein the at least one operational metric associated with operations of the wireless client in the WLAN infrastructure comprises at least one of a Received Signal Strength Indicator (RSSI), Modulation Coding Scheme (MCS), state of TX buffer of the wireless client, number of connection retries, contention time, and Media Access Control (MAC) service data unit (MSDU) aggregation.

16. The system of claim 13, wherein the at least one operational metric associated with operations of the wireless client in the WLAN infrastructure comprises at least one of voice or video packet loss, voice or video buffer depth, change to codec quality, roaming tendency, periods of no frame transmission or no association, missing beacon, and battery usage.

17. The system of claim 13, wherein the client experience score includes an indication of a level of effort used to generate the client experience score.

18. One or more non-transitory computer readable storage media encoded with instructions that, when executed by a processor, cause the processor to:
detect, by a wireless client, at least one operational metric associated with operations of a wireless local area network (WLAN) infrastructure, wherein the at least one operational metric is determined by the wireless client in response to wireless service supplied by the WLAN infrastructure;
generate a client experience score based on the at least one operational metric; and
transmit the client experience score to at least one of an access point (AP) and a wireless network controller, which are configured to adjust, in response to the client experience score, at least one operational parameter of the WLAN infrastructure to cause a change to the at least one operational metric and to a subsequently generated client experience score.

19. The one or more non-transitory computer readable storage media of claim 18, wherein the instructions are configured to transmit the subsequently generated client experience score to the AP.

20. The one or more non-transitory computer readable storage media of claim 18, wherein the instructions are configured to include with the client experience score an indication of a level of effort used to generate the client experience score.
